(19) United States
(12) Patent Application Publication
(10) Pub. No.: US 2023/0368186 A1
(43) Pub. Date: Nov. 16, 2023

(54) Process for Creation storage retrieval of immutable NFT Non-fungible token based electronic book publishing on a decentralized proof ofstake blockchain

(71) Applicant: David Exline, Gibsonia, PA (US)

(72) Inventor: David Exline, Gibsonia, PA (US)

(21) Appl. No.: 18/135,124

(22) Filed: Apr. 15, 2023

Related U.S. Application Data
(60) Provisional application No. 63/341,430, filed on May 13, 2022.

(51) Int. Cl. G06Q 20/36; G06Q 20/38

(52) U.S. Cl. CPC G06Q 20/3672; G06Q 20/389

(57) ABSTRACT

A method relates to a novel approach for utilization of NFTs (Non-Fungible Tokens) as the basis for electronic book publishing creation and storage. Every submission carries its own unique, immutable identity. This process applies this concept to grant users access to a unique decentralized, non-custodial digital document storage solution on the market. This process remains focused on cultivating robust systems around minting, validating, retrieving & verifying NFT-based documentation. This is accomplished by, the method described to mint, archive, and retrieve NFT published electronic books using a proof-of-stake blockchain.

### COPYRIGHT NOTICE

A portion of this patent document's disclosure contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates to digital publishing protection, particularly a digital copyright protection method based on blockchain technology.

### Description of the Related Art

As blockchain and crypto have continued to gain attention and popularity over the past year, non-fungible tokens have surged into the spotlight. NFTs are cryptographic tokens that cannot be replicated. Many kinds of transactions can use them, and they may create new markets in the future. Non-fungible tokens are unique digital assets that can be created and traded on blockchain networks. It is a non-interchangeable unit of data stored on a blockchain that can be sold and traded. NFTs are not investments, so make sure to understand the value of the underlying asset that you are buying before you purchase the NFT. These blockchain assets are likely to emerge as an important pillar of the new economy with important implications for privacy and security. Blockchain is currently one of the most-hyped technologies. Blockchain technology is a great example of the unrelatedness of security and privacy. It can also help to improve defensive cybersecurity strategies, especially in terms of identity and access

Multiple solutions have been presented in prior art regarding the effective utilization of NFTs and blockchain technology security. For instance, CN patent 1,073,92608B discloses a digital asset transaction method based on blockchain and blockchain systems. The blockchain system is a tree-shaped distributed blockchain system comprising a plurality of levels of blockchains. The method includes the following steps: the first blockchain receives a digital asset transaction request from a client and determines a digital asset corresponding to the digital asset transaction request; judging whether a home blockchain corresponding to the digital asset is the first blockchain; if yes, the first blockchain processes the digital asset transaction request; if not, the first blockchain refuses the digital asset transaction request; wherein, the attribution blockchain corresponding to the digital assets is the blockchain generating the digital assets. This approach is particularly useful for transactions that use a digital asset at a time, which can only be used once; in addition, the method can also realize cross-chain transactions among the digital assets, and the digital assets before and after the cross-chain transaction are executed respectively correspond to different attribution blockchains so that the safety of the assets is improved.

A CN patent 1,086,83630B implies one or more embodiments of the present specification provide a method and an apparatus for authenticating a cross-blockchain, and an electronic device, which is applied to a cross-chain interaction system composed of a subscription client, a publication client, and a cross-chain client; wherein the subscribing client corresponds to a first blockchain; the publishing client corresponds to the second blockchain; the cross-chain client is respectively butted with the subscription client and the publishing client; the method comprises the following steps: the subscription client acquires the data on the second blockchain published by the publishing client through the cross-chain client as an authentication data source; receiving data to be authenticated from the second blockchain, and performing data authentication on the data to be established based on the authentication data source and the data authentication rule configured on the first blockchain.

US patent 2,017,0132630A1 provides a system operatively connected with a blockchain distributed network and for using the blockchain distributed network for mapping aliases. Embodiments create an alias-token pair linking an alias associated with a customer to a token associated with an account owned by the customer and map the alias-token pair to an address associated with the customer on a directory services (DS) blockchain. In some cases, the system manages the alias-token lifecycle, including enabling editing and deleting the alias-token pair mapped to the address. In some cases, the system registers the customer's address with the DS blockchain. Such registering may include receiving a selection from the customer regarding the desired node for registering the customer address, connecting with the DS blockchain, and creating an account associated with the customer, including creating a unique address associated with the customer and registering it with the DS blockchain.

U.S. Pat. No. 1,074,9865B2 implies Blockchain/distributed ledger-based verification of entity identity, or verification of a relationship between two or more entities may be provided. Verification addresses may be established on a blockchain/distributed ledger by associating identifiers and verifiers with entities having previously verified entity identities or having previously verified relationship(s) with other entities, assigning verification addresses on a blockchain/distributed ledger to the entities, and recording entity identifier(s), identity verifier data and relationship verifier data associated with the entities at corresponding verification addresses. Embodiments for blockchain/distributed ledger-based verification of entity identity and/or proof of entity's relationship to a related entity(ies) using the verification addresses are performed using one or more identity verifiers and/or one or more relationship verifiers.

A US patent 2,017,0302663A1 implies that a network device receives a network registration request from a particular node in one embodiment. The network registration request comprises information about the specific node. The device causes the performance of validating the information on the particular node via comparison of the information about the particular node to a distributed blockchain that includes information regarding the specific node and one or more other nodes. The device causes an update to the blockchain-based on the information about the particular node and the validation of the information about the particular node. The device uses the updated blockchain to control the behavior of the specific node and one or more other nodes.

A U.S. Pat. No. 1,117,1782B2 discloses system and techniques for identity and electronic signature verification that utilizes blockchain technology. An enterprise system enables computing devices to engage the enterprise and prospective users to execute a document or a smart contract. Users may obtain a computer application from an enterprise system and may utilize the computer application to retrieve a document or select a smart contract. The identity of all users who execute the document may be verified based on authentication by a trusted independent system. Information related to the respective signers, the document or smart contract, and the authentication may be stored as transactions in a blockchain. If available, the transactions may be stored in the blockchain under a user's address, a document or smart contract address, or a digital wallet.

U.S. Pat. No. 8,543,842B2 provides systems and methods for secure transaction management and electronic rights protection. Electronic appliances such as computers equipped following the present invention help ensure that information is accessed and used only in authorized ways and maintain the information's integrity, availability, and/or confidentiality. Such electronic appliances provide a distributed virtual distribution environment (VDE) that may enforce a secure chain of handling and control, for example, to control and/or meter or otherwise monitor the use of electronically stored or disseminated information. Such a virtual distribution environment may be used to protect the rights of various participants in electronic commerce and other electronic or electronic-facilitated transactions. Distributed and other operating systems, settings, and architectures, such as, for example, those using tamper-resistant hardware-based processors, may establish security at each node. These techniques may support an all-electronic information distribution, for example, utilizing the “electronic highway.”

A US patent 2,020,0065380A1 implies a method, computer system, and a computer program product for document clearance are provided. The present invention may include receiving content. The present invention may also include extracting the received content features. The present invention may then include determining a level of sensitivity based on the extracted content features. The present invention may further include identifying an approver based on the determined level of sensitivity. The present invention may also include transmitting the content to the identified approver.

Within alternate ecosystems, the deployment of self-publishing and electronic books (i.e., ebooks) via blockchain technology has been complex due to gas fees and transactional delays. As a result, the maturity of the proof of stake (POS) Blockchain has created an environment that allows us to leverage a more robust blockchain ecosystem while taking advantage of inexpensive processing fees for minting through proof-of-stake. This enables creating a robust system around validating, transferring, retrieving, and verifying NFT-based documentation.

Utilizing NFTs (Non-Fungible Tokens) as the basis for book publication creation and storage means every submission carries its own unique, immutable identity. This process applies this concept to grant users access to a unique decentralized, non-custodial digital document storage solution on the market. This process remains focused on cultivating robust systems around minting, validating, retrieving & verifying NFT-based publishing of documents such as books, literature, etc.

Conventional documents published by the most influential companies globally, or small businesses and sole-proprietorships alike, require scanned documents or some electronic process based on a KYC verification system. Although these processes add security to corporate documentation, this method does not provide the level of security and accountability that should be upheld within regulatory frameworks. Furthermore, it opens the floodgates to forgery, fraud, and lack of accountability witnessed in the last century.

With this dilemma in question, the concept of Blockchain technology provides the clearest solution. The current invention aims at developing the first non-custodial, decentralized electronic document creation, storage, and retrieval platform, deployed within immutable native assets (NFTs) minted on the proof of stake Blockchain; this process provides the real-world use-case for non-fungible tokens as the basis for electronic publishing enabling authentication and verification using proof-of-stake blockchain.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a complete description. A full appreciation of the various aspects of the invention can be gained by taking the entire specification, claims, drawings, and abstract.

The primary desirable object of the present invention is to provide a novel and improved method for securely designed applications that ensure the security and authenticity of original literary work in blockchain technology.

The invention's primary objective is to provide a smart methodology directed to devices, systems, and methods for facilitating a decentralized application that ensures the security and authenticity of published works such as electronic books and other writings.

Another objective of the invention is to provide a system replacing the earlier used tools such as the KYC verification system and provide a new concept which was the requirement of the time.

It is also the object of the invention to provide an advanced system that provides a secure payment of the NFT on the proof of stake Blockchain through user wallet access with payment tokens, utility tokens, security tokens, or non-fungible tokens.

Further, the invention's objective is to provide an advanced system where the minting of documents will be verified on the proof-of-stake blockchain and stored within a decentralized non-custodial vault for retrieval.

Other aspects, advantages, and novel features of the present invention will become apparent from the detailed description when considered in conjunction with the accompanying drawings.

This summary is provided merely to summarize some example embodiments to provide a basic understanding of some aspects of the subject matter described herein. Accordingly, it will be appreciated that the above-described features are merely examples and should not be construed to narrow the scope or spirit of the subject matter described herein. Other features, aspects, and advantages of the subject matter described herein will become apparent from the detailed description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a complete process chart in accordance with the present invention.

FIG. 2 is another process chart showing the working of the system in accordance with the present invention.

Skilled artisans will appreciate those elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. However, it is to be understood that the present invention may be embodied in various forms. Therefore, specific details disclosed herein are not to be interpreted as limiting but rather as a basis for the claims and a representative basis for teaching one skilled in the art to employ the present invention in virtually any appropriately detailed system, structure, or manner.

The terminology used herein is to describe particular embodiments only and is not intended to limit the invention. The term “and/or” includes any combinations of one or more of the associated listed items. As used herein, the singular forms “a,” “an,” and “the” are intended to include the plural forms as well as the singular forms unless the context indicates otherwise. It will be further understood that the terms “comprises” and/or “comprising,” when used in this specification, specify the presence of stated features, steps, operations, elements, and/or components but do not preclude the presence or addition of one or more other features, steps, operations, parts, components, and/or groups thereof.

The ability to efficiently and reliably establish that a document (a computer file) has existed as of a specific date. Further, it has not been altered by tampering since that date has been an elusive target for certain types of documents. The rapidity of the digital era and the accessible copying property of the works make the internet copyright management increasingly complex. The cost of piracy infringement is significantly reduced, which causes significant loss to copyright owners and the whole copyright industry. From the correct maintaining link, the tracing chain is longer. First, it is difficult to define the infringement, and the infringement needs to be determined by checking the authorization description stage by stage. Especially for digital content such as sound and images, it is easier to cause a dispute for ownership. This hinders the spread of digital rights because it is difficult to distinguish between “original edition” and “imitation.” Secondly, the right is difficult to trace back, and after the infringement is determined, the right is difficult to trace back to the source. Taking music copyright as an example, the person of the word song has the copyright of the word song, and the singer has the song's copyright. A series of rights such as copyright, distribution right, playing right, and showing ownership are crossed, and the complexity of the rights attribution is conceivable. Finally, the phenomenon of copyright violation in history in China is severe. It is very common to download pirated music and not mark reference sources, which significantly hinders the healthy development of the content market.

Blockchain technology enables the copyright works to be registered to realize self-supervision, centralization is achieved, the management cost is greatly reduced, and the safety of a registration database is improved. Firstly, theoretically, due to the characteristic of decentralized blockchain, the method for registering the copyright works does not need authentication and management of a third party in the future, avoids the long process of authorization of a traditional organization, and is directly supervised by the whole network, and significantly saves the cost of copyright owners, the management cost of the management and the management cost of a registered organization. Because the blockchain technology has the unchangeable specific, the copyright works do not need various authentication materials to prove their originality of the copyright works, and the blockchain technology can confirm the works. Meanwhile, due to the structural characteristics of the blockchain, the registration information of any original work is unique, and the unique timestamp record exists no matter the content information or the creation time of the work. This provides a solution for the absolute right of copyrighted works. On the one hand, the copyright infringement cost can be significantly improved; on the other hand, the infringement is monitored timelier, and a foundation is provided for proper real-time maintenance. Blockchain technology can create a new protection system for copyright registration, good confirmation, and the right care.

The present invention is directed to an advanced methodology aimed at providing a novel process for the creation/storage/retrieval of immutable NFT (Non-fungible token) based electronic book publishing on a decentralized proof-of-stake blockchain

As per its preferred embodiments, the technology provides a method for a decentralized application that ensures the security and authenticity of published works such as electronic books and other writings. Native tokens allow users to mint documents as an immutable NFT (Non-Fungible Token) on the proof of stake Blockchain, paid for through user wallet access with native tokens. At this point, the minting transaction holding your document will be submitted and verified on the blockchain and stored within a decentralized non-custodial vault for retrieval.

The lack of accountability, transparency, and security in business practices has plagued humanity. Blockchain technology represents the first opportunity for verifiable, non-custodial, immutable electronic book storage & retrieval applications. We utilize the blockchain as both an audit trail and the version tracking system for documents with this concept. Each epoch (block) represents an earlier version of the immutable document, enabling anyone to backtrack its history for verification.

The technology, as per its additional embodiments, also proposes an electronic device for the implementation of the system, including:
a processor;
a memory for storing machine-executable instructions;
Wherein, by reading and executing machine-executable instructions stored by the memory corresponding to control logic based on authentication of a blockchain across blockchains. In some embodiments, the processing device is configured to execute computer-readable program code further to manage NFT.

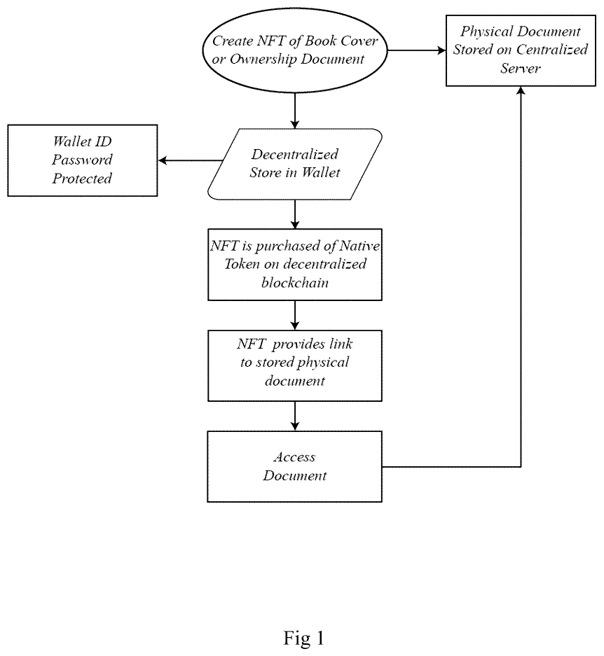

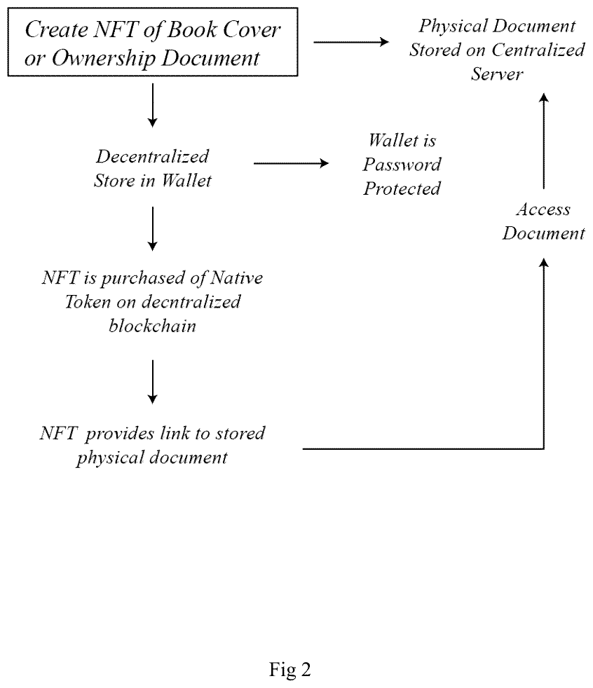

By looking at FIG. 1 and FIG. 2 working of the system can be understood in detail. FIG. 1 shows the process initiation wherein the creation of NFT for a book cover or ownership document is performed. The data is stored in the decentralized wallet and is protected with a password. The NFT is purchased of the native token on the decentralized blockchain. The NFT provides a link to stored physical documents once the user is successfully authorized.

FIG. 2 shows the creation of NFT of a book cover or ownership document whether it's a virtual document or physical document, it will be stored in a decentralized wallet and centralized server respectively. The wallet is password protected and NFT is purchased off the native token on a decentralized blockchain. The NFT further provides a link to the stored physical documents and allows the user to access and modify it as per the individual's requirements.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to it without departing from its spirit. Therefore, it is not intended that the scope of the invention be limited to the specific embodiment illustrated and described. Instead, it is intended that the appended claims and their equivalents determine the scope of this invention.

The Abstract of the Disclosure is provided to allow the reader to ascertain the technical disclosure's nature quickly. It is submitted with the understanding that it will not be used to interpret or limit the scope or meaning of the claims. In addition, in the preceding Detailed Description, it can be seen that various features are grouped in various embodiments to streamline the disclosure. This method of disclosure is not to be interpreted as reflecting an intention that the claimed embodiments require more features than are expressly recited in each claim. Instead, as the following claims reflect, the inventive subject matter lies in less than all features of a single disclosed embodiment. Thus, the following claims are hereby incorporated into the detailed description, with each claim standing on its own as a separately claimed subject matter.

1. A system operatively connected with a blockchain distributed network and using the blockchain distributed network for providing a digital copyright protection method, the system comprising:
establishing a blockchain technology-based copyright protection system overall function framework,
a memory device; and
a processing device operatively coupled to the memory device, wherein the processing device is configured to execute computer-readable program code to:
creation of unique NFT as the basis for document creation and storage; and,
mapping the immutable NFT (Non-Fungible Token) on a proof of stake Blockchain, through user wallet access with native tokens.

2. The system of claim 1, wherein the processing device is configured to execute computer-readable program code further to:
Facilitate minting electronic books as immutable NFT (Not-Fungible Tokens) on a proof of stake Blockchain.

3. The system of claim 1, wherein the processing device is configured to execute computer-readable program code further to:
Facilitate payment of the NFT on the proof of stake Blockchain through user wallet access with payment tokens, utility tokens, security tokens, or non-fungible tokens.

4. The system of claim 1, wherein the processing device is configured to execute computer-readable program code further to:
Facilitate payment of the NFT on the proof of stake Blockchain through user wallet access with proof of stake compatable native tokens.

5. The system of claim 1, wherein the processing device is configured to execute computer-readable program code further to:
Provide a method of minting transactions holding electronic books will be submitted and verified on the proof-of-stake blockchain and stored within a decentralized not-custodial vault for retrieval.

6. The system of claim 1, wherein the processing device is configured to execute computer-readable program code further to:
Facilitate minting of documents as NFTs on the proof of stake Blockchain, including but not limited to electronic books.
